(19) United States
(12) Patent Application Publication
(10) Pub. No.: US 2003/0163339 A1
(43) Pub. Date: Aug. 28, 2003

(54) Process of accessing live activities and events through internet

(76) Inventor: John Elliot, San Marino, CA (US)

Correspondence Address: RAYMOND Y. CHAN, 1050 OAKDALE LANE, ARCADIA, CA, 91006, US

(21) Appl. No.: 10/081,680

(22) Filed: Feb. 25, 2002

(51) Int. Cl. G06F 17/60

(52) U.S. Cl. 705/1

(57) ABSTRACT

A process of accessing live activities and events through Internet includes the steps of: capturing at least a live action event having at least one participant carrying at least a video camera supported on an eye level position of the participant for capturing the live action event from a point of view of the participant; uploading the live action event to a central control site through Internet; and broadcasting the live action event to a subscriber via the central control site through Internet. Therefore, each subscriber is able to view the live action event from the participant's point of view as the subscriber is virtually participating.

### BACKGROUND OF THE PRESENT INVENTION

1. Field of Invention

The present invention relates to a system and method for receiving transmissions of a plurality of live activities and events for direct video transmission to subscribers of the live activities and events through the Internet and more particularly, where several transmissions of such live activities and events are received from different event locations to a central hub where subscribers may choose among a group of live activities and events and then be directly connected with the event as it is occurring, and in which the transmission is shown from the perspective of the participant in the live activities and event.

2. Description of Related Arts

With the advent of the Internet, life has suddenly become much faster. Information, business, and conversation are just a click of a mouse away. With the Internet has come the opportunity for greater stimulation. One can immediately see pictures of an African desert, download a new song, watch a live interview or watch a tape of an interview.

Concurrently, for years, entertainment companies have provided television shows and movies designed to allow people to vicariously experience adrenalin pumping activities. Whether it is following a speeding car chase, or watching a snow boarder snowboard down a sheer face of snow, the viewer watches the participants as they act. Similarly, the increase in television coverage of “extreme” sports, such as the survival trek races, triathlons, and mountain climbing expeditions all provide the consumer with a vicarious thrill. Even the recent spate of real world shows such as “the Real World” by MTV, or “Survivor” by CBS are shown which allow the viewer to watch the lives of others, to receive stimulation without having to go though it themselves. Most often, these events have been taped and then provided to the consumer as an event the consumer can watch later. In the event of live action shows, such as the Tour de France, the viewer is limited to watch excerpts of the action based upon what the television companies can show, or what companies decide to edit. Most often these are from sideline shots, with occasional quick shots to give the view an idea of what the participant is seeing.

The Internet has provided more opportunities for the consumer to view a greater variety of activities in a different way. However, just as in television, activities broadcast over the Internet, or focus on a view of a spectator. Also, live action broadcasts are usually shown on an infrequent basis. Furthermore, there is no website that provides for its members a live action event at all times of the day.

It is desirable to provide an Internet based system for providing a group of live action events to a group of paying subscribers, whereby the events may be transmitted from any location and accessed directly by any of the subscribers who then observe the action as it is occurring, from the point of view of the participant in the live action and the subscribers have choices of live events occurring throughout the day.

### SUMMARY OF THE PRESENT INVENTION

A main object of the present invention is to provide a process of accessing live activities and events through Internet wherein a group of live action events is video transmitted via the Internet to paying subscriber.

Another object of the present invention is to provide a process of accessing live activities and events through Internet wherein a camera is placed at eye-level of participant such that the subscribers view the live action event from the point of view (“POV”) of the participant in the live action event.

Another object of the present invention is to provide a process of accessing live activities and events through Internet, wherein the subscribers may choose among a group of live action events occurring throughout the entire day.

Another object of the present invention is to provide a process of accessing live activities and events through Internet, wherein the live events are captured on camera, transmitted over conventional technology, such as telephone wire, satellite, cable, or other wireless transmission means to a central unit and almost simultaneously are made available for multitude of individuals to view the live action event as the event is happening.

Another object of the present invention is to provide a process of accessing live activities and events through Internet, wherein the live action events includes events in remote places of the world.

Another object of the present invention is to provide a process of accessing live activities and events through Internet, wherein the subscribers may download the event from the Internet as they watch it.

Another object of the present invention is to provide a process of accessing live activities and events through Internet, wherein the subscribers are provided with a menu of commands to choose among a menu of live action events.

Another object of the present invention is to provide a process of accessing live activities and events through Internet, wherein the subscribers are provided with a menu of commands to choose among a menu of options to enhance the viewing of the live action event.

Another object of the present invention is to provide a process of accessing live activities and events through Internet, wherein the subscribers may interact with the participant as the participant is acting the live action event.

Another object of the present invention is to provide a process of accessing live activities and events through Internet, wherein the live action events transmitted are from locations.

Accordingly, in order to accomplish the above objects, the present invention provides a process of accessing live activities and events through Internet, comprising the steps of:

(a) capturing at least a live action event by having at least one participant carrying at least a video camera supported on an eye level position of the participant for capturing the live action event from a point of view of the participant;

(b) uploading the live action event to a central control site through Internet; and

(c) broadcasting the live action event to a subscriber via the central control site through Internet.

### BRIEF DESCRIPTION OF THE DRAWINGS

FIG. 1 is a block diagram illustrating a process of accessing live activities and event through Internet according to a preferred embodiment of the present invention.

FIG. 2 is a flow chart illustrating a process of accessing live activities and event through Internet according to the above preferred embodiment of the present invention.

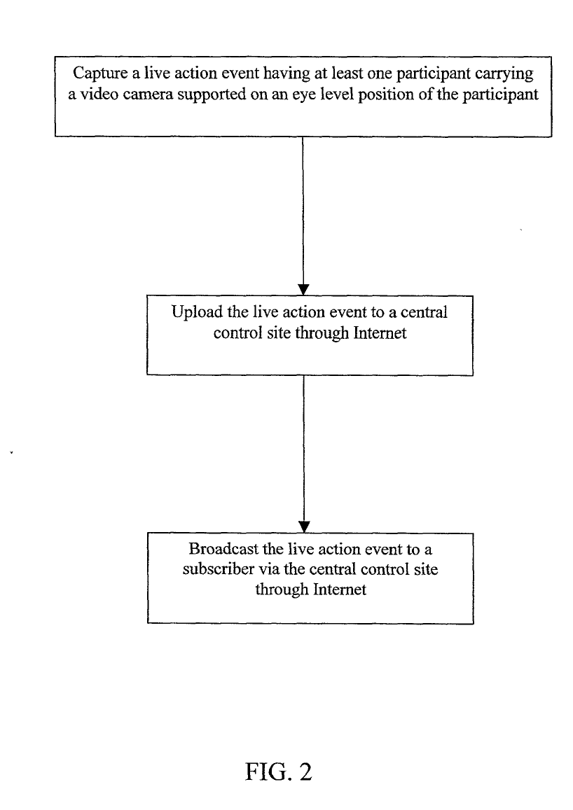

FIG. 3 illustrates a participant carrying a camera to capture a live activity from a point of view of the participant according to the above preferred embodiment of the present invention.

### DETAILED DESCRIPTION OF THE PREFERRED EMBODIMENT

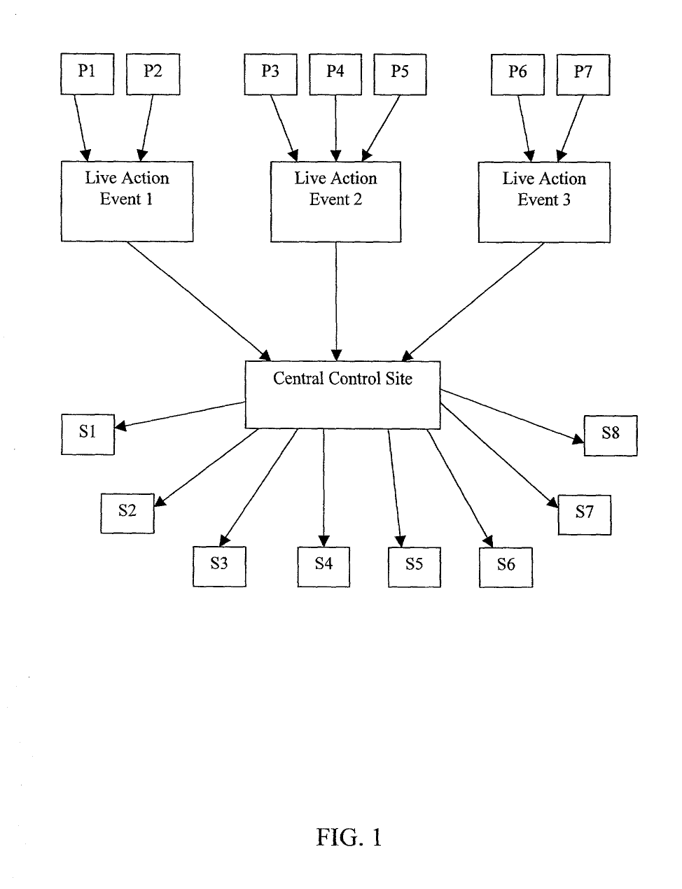

Referring to FIG. 1 of the drawings, according to a preferred embodiment of the present invention, a process of accessing live activities and events through Internet comprises the following steps.

(1) Capture at least a live action event by having at least one participant P carrying at least a video camera supported on an eye level position of the participant P for capturing the live action event from a point of view of the participant P.

(2) Upload the live action event to a central control site through Internet.

(3) Broadcast the live action event to a subscriber S via the central control site through Internet.

The live action event is selectively provided by the central control site 24 hours a day, 7 days a week, which can be a central computer center located at one or more designated places anywhere in the world. The central control site, which is owned and managed by a headquarter, comprises at least an Internet website available for users and/or subscribers S to enter anytime. The central control site not only acts as an information center for users to research information of the live action event such as a schedule of live action events but also is a central managing center for managing operation of the live action events such as broadcasting the live action events.

The live action event can be classified into various categories such as adventure, horror, or special event that requires at least a participant P participates in the live action event. Each participant P should carry at least a camera supported on his or her eye level in such a manner that the action as the participant P sees will be instantly captured by the camera by using known fiber optic technology.

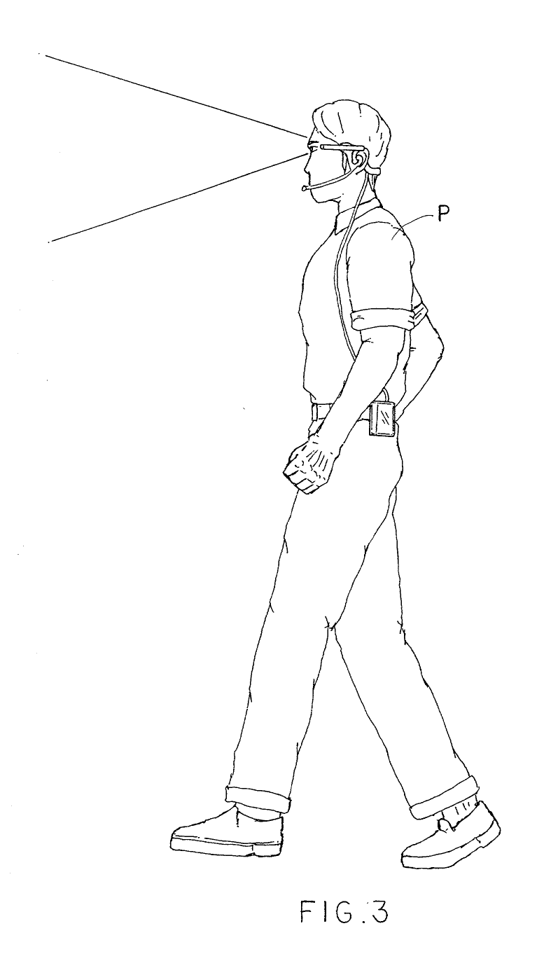

As shown in FIG. 3, the participant P carries the video camera via a head set wherein the video camera is mounted on the head set at a position same as the eye level of the participant P in such a manner that the participant P is able to capture the live action event at the eye level position thereof. Accordingly, when the participant P turns his or her head, the video camera will correspondingly move to a position that captures what the participant sees. In other words, the video camera is operated by the participant P according to the head movement thereof. The video camera should be incorporated with a wireless transmitter that carried by the participant P in such a manner that the live action event captured by the video camera can be directly transmitted through the wireless transmitter to the control center.

The live action event can be captured as a daily life of the participant P, such as walking on the beach, or dancing in the party, such that the subscriber is able to view a real life of the participant P. Otherwise, when the participant P participates the special event, such as ski jumping, the video camera will capture the live action event such that the subscriber will act as a first person to participate the special event while watching the live action event.

The live action captured from the camera is converted from a video input signal to a stream of data which is computer readable bits of information and then transmitted through conventional systems such as telephone line, satellite, cable, cellular phone, radio waves, etc. to the central control site.

In order to access the live action event, the step (2) further comprises the sub-steps of:

(2a) Request each of the subscribers S to pay a predetermined amount of membership fee in order to register as a member; and

(2b) Assign a password and a member ID for each of the members.

In the step (2a), each member (registered subscriber) should submit the predetermined membership fee to the central control sit for providing services for each member and supporting the live action event.

Alternatively, the central control site may have at least a sponsor in order to support the live action event such as placing an advertisement bar or icon on the monitor screen of the subscribers S during broadcasting the live action events.

In step (2b), each member can use the assigned password and member ID to log on in the website in order to access the live action event. Each subscriber S connects to the central control site by using his or her own Internet based machine, which may be a computer, a television, or a handheld device, etc. to then connect to the central control site to see the live action event at his or her screen monitor. Upon logging in, a menu is appeared on the screen giving the subscribers S several options, only requiring the subscriber S to click on the option in order to start that option. The subscriber S may look at the schedule of live action events to see what live action is currently, or will be playing. The subscriber S may then click on to the event he or he wishes to see, and he or she is immediately connected to the live action event through the central control site.

The process of accessing live activities and events through Internet further comprises the following steps.

(3a) Provide an option menu comprising a data of past live action events, current live action events, and coming live action events.

The subscriber S may also choose other options in the option menu to use while enjoying such live action events, such as receiving narrative from a commentator (a “POVjay”), or playing certain music which is stored at the central control site, or playing certain music which is stored another website, but linked to the website of the central control site, or capturing a snapshot photo of the action, or a video of the downloaded event as it is occurring.

When more than one participant P participate in the live action event, the subscriber S is able to select the live action event from different point of views of the participates P play on screen at the same time such that the subscriber S is able to see how the participant P incorporates with another participant P in the live action event. Thus, each subscriber S is also able to select more than one live action event at the same time so as to see different participants P participated in different live action events. In other words, the subscriber S can see a participant P explores the Arctic regions and another participant P ghost hunts in Europe at the same time.

The central control site not only connects the subscribers S to the live action event location, but also stores the live action event for subscribers S to view later on as well. The central control site also stores data obtained from the subscribers S, and programs and data for any options that might be used by the subscriber S. The central control site also provides links on its website to other websites.

The subscriber S can invite another subscriber S to join the live action event such as enter into a chat room provided in the website wherein the chat room of the website can not only meet the subscriber S but also discuss the live action event to the central control site such as suggestion of a new live action event or communication with the participant P.

In operation, the subscriber S first accesses the website via the Internet. Upon accessing the website, the subscriber S then logs in, based upon a previously set up account. The menu option is then provided to the subscriber S, in the form of a framed picture, much like the frame around the monitor screen. Along the edges of the frame, there are options from which the subscriber S may choose. The subscriber S than may choose a live action event from a list of events currently in progress. The subscriber S may also look at an upcoming calendar of live action events or choose an archived event. After choosing a live action event, the subscriber S may then choose the option of playing music during the event, or may choose the option of downloading a copy of the live action as it is occurring, and as the subscriber S is “virtually participating.”

After the subscriber S chooses the event, the central control site directs the incoming video feed to the subscriber's location. As the participant acts, the subscriber S sees what the participant sees through the participant's POV. If the participant P looks down to check his own equipment, or looks off in the distance at someone or some object, the subscriber S sees looks at the subject as if the subscriber was doing the action, a virtual participant.

In some instances, the subscribers S who are virtually participating may interact with the participant P, via the head set, through a third person relaying messages while the action is going on, or just before the action begins, either guiding the participant P in his actions, requesting the participant P act in certain ways, making the activity even more realistic, or simply asking the participant P the reason for his actions or movements. Accordingly, the participant P is adapted for interacting with the subscribers S through the third person by a microphone set on the head set, as shown in FIG. 3.

In some instances, a subscriber S and the virtually participating subscriber proceed.

The subscriber S also has the option menu comprising a musical arrangement having a plurality of music adapted for being selected by the subscriber S to play during the live action event. The music can be downloaded located at the central control site to play while the live action event is occurring. The subscriber S may also use music from another website linked to the central control website.

After the event is over, for events where the participant P is a person, the subscriber S has the option of interacting with the participant P, asking questions regarding the live action event to supplement the subscriber's own virtual participation.

What is claimed is:

1. A process of accessing live activities and events through Internet, comprising the steps of:
(a) capturing at least a live action event having at least one participant carrying at least a video camera supported on an eye level position of said participant for capturing said live action event from a point of view of said participant;
(b) uploading said live action event to a central control site through Internet; and
(c) broadcasting said live action event to a subscriber via said central control site through Internet.

2. The process, as recited in claim 1, wherein said participant carries said video camera via a head set, wherein said video camera is mounted on said head set at a position as same as said eye level position of said participant.

3. The process, as recited in claim 1, wherein said central control site not only acts an information center for subscribers to research information of said live action event through Internet but also is a central managing center for managing operation of said live action events.

4. The process, as recited in claim 2, wherein said central control site not only acts an information center for subscribers to research information of said live action event through Internet but also is a central managing center for managing operation of said live action events.

5. The process, as recited in claim 1, further comprising an additional step of accepting at least a sponsor to support said live action event by placing advertisement on a monitor screen of said subscribers during broadcasting said live action events.

6. The process, as recited in claim 2, further comprising an additional step of accepting at least a sponsor to support said live action event by placing advertisement on a monitor screen of said subscribers during broadcasting said live action events.

7. The process, as recited in claim 4, further comprising an additional step of accepting at least a sponsor to support said live action event by placing advertisement on a monitor screen of said subscribers during broadcasting said live action events.

8. The process, as recited in claim 1, wherein in said step (C) further comprises a step of providing an option menu comprising a data of past live action events, current live action events, and coming live action events for said subscriber to select.

9. The process, as recited in claim 2, wherein in said step (C) further comprises a step of providing an option menu comprising a data of past live action events, current live action events, and coming live action events for said subscriber to select.

10. The process, as recited in claim 4, wherein in said step (C) further comprises a step of providing an option menu comprising a data of past live action events, current live action events, and coming live action events for said subscriber to select.

11. The process, as recited in claim 7, wherein in said step (C) further comprises a step of providing an option menu comprising a data of past live action events, current live action events, and coming live action events for said subscriber to select.

12. The process, as recited in claim 8, wherein said option menu further comprises a musical arrangement having a plurality of music adapted for being selected by said subscriber to play during said live action event.

13. The process, as recited in claim 9, wherein said option menu further comprises a musical arrangement having a plurality of music adapted for being selected by said subscriber to play during said live action event.

14. The process, as recited in claim 10, wherein said option menu further comprises a musical arrangement having a plurality of music adapted for being selected by said subscriber to play during said live action event.

15. The process, as recited in claim 11, wherein said option menu further comprises a musical arrangement having a plurality of music adapted for being selected by said subscriber to play during said live action event.

16. The process, as recited in claim 2, wherein said participant is capable of interacting with said subscribers, via said head set, through a third person relaying messages during said live action event.

17. The process, as recited in claim 4, wherein said participant is capable of interacting with said subscribers, via said head set, through a third person relaying messages during said live action event.

18. The process, as recited in claim 7, wherein said participant is capable of interacting with said subscribers, via said head set, through a third person relaying messages during said live action event.

19. The process, as recited in claim 11, wherein said participant is capable of interacting with said subscribers, via said head set, through a third person relaying messages during said live action event.

20. The process, as recited in claim 15, wherein said participant is capable of interacting with said subscribers, via said head set, through a third person relaying messages during said live action event.

21. The process, as recited in claim 4, wherein said central control site provides at least a chat room for said subscribers involved in said live action event to communicate with each other throughout said live action event and thus to communicate with said central control site.

22. The process, as recited in claim 7, wherein said central control site provides at least a chat room for said subscribers involved in said live action event to communicate with each other throughout said live action event and thus to communicate with said central control site.

23. The process, as recited in claim 11, wherein said central control site provides at least a chat room for said subscribers involved in said live action event to communicate with each other throughout said live action event and thus to communicate with said central control site.

24. The process, as recited in claim 15, wherein said central control site provides at least a chat room for said subscribers involved in said live action event to communicate with each other throughout said live action event and thus to communicate with said central control site.

25. The process, as recited in claim 20, wherein said central control site provides at least a chat room for said subscribers involved in said live action event to communicate with each other throughout said live action event and thus to communicate with said central control site.
